(19) United States
(12) Patent Application Publication
(10) Pub. No.: US 2024/0378412 A1
(43) Pub. Date: Nov. 14, 2024

(54) METHODS FOR TOPOLOGICAL DATA ANALYSIS AI/ML PIPELINE (TDAML) WITH ALGORITHM FOR MULTIMODAL SENSOR DATA FUSION IN AUTONOMY APPLICATIONS

(71) Applicant: Government of the United States as represented by the Secretary of the Air Force, Rome, NY (US)

(72) Inventor: Paul Thomas SCHRADER, Clinton, NY (US)

(73) Assignee: Government of the United States as represented by the Secretary of the Air Force, Rome, NY (US)

(21) Appl. No.: 18/645,545

(22) Filed: Apr. 25, 2024

Related U.S. Application Data
(60) Provisional application No. 63/499,338, filed on May 1, 2023.

(51) Int. Cl. G06N 3/04

(52) U.S. Cl. CPC G06N 3/04

(57) ABSTRACT

A method of topological data analysis feature engineering for data fusion and autonomy is provided. The method comprises providing a Topological Data Analysis AI/ML Pipeline (TDAML) algorithm for multimodal sensor data fusion in autonomy applications system further comprising combining raw heterogeneous multimodal sensor data at the topological level; measuring, recording, and tracking linear representations of an underlying data set; providing a linear representation of the underlying data set which is compatible to existing deep learning (DL) model architectures for training in autonomy tasks; and accessing the entire degree of freedom (DOF) space of raw multimodal sensor data for mitigating sensor modality adversarial threats and environmental attenuation concerns in contested military and civilian (urban) environments.

### REFERENCE TO RELATED APPLICATIONS

Pursuant to 37 C.F.R. § 1.78 (a)(4), this application claims the benefit of and priority to prior filed co-pending Provisional Application Ser. No. 63/499,338 filed May 1, 2023, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to raw multimodal sensor data information extraction and analysis, and more particularly to topological data analysis feature engineering of data interfaced with deep learning for data fusion and autonomy applications.

### SUMMARY OF THE INVENTION

While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a method of topological data analysis feature engineering for data fusion and autonomy comprises providing a Topological Data Analysis AI/ML Pipeline (TDAML) algorithm for multimodal sensor data fusion in autonomy applications system further comprising combining raw heterogeneous multimodal sensor data at the topological level; measuring, recording, and tracking linear representations of an underlying data set; providing a linear representation of the underlying data set which is compatible to existing deep learning (DL) model architectures for training in autonomy tasks; and accessing the entire degree of freedom (DOF) space of raw multimodal sensor data for mitigating sensor modality adversarial threats and environmental attenuation concerns in contested military and civilian (urban) environments.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a block diagram illustrating a TDAML example with data structures, a TDAML functional module, and a TDAML decision structure module;

FIG. 2 is a block diagram illustrating an example of Sub Diagram 1 as referenced in FIG. 1; and

FIG. 3 is a block diagram illustrating an example of Sub Diagram 2 as referenced in FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

One cannot overemphasize the importance of situational assessment (SA) and awareness (SAW) in military and civilian contested operational environments. Heterogeneous multimodal sensor/multi-intelligence data from embedded and stand-alone assets continuously inundate military and civilian environment alike. These collects should effectively contribute to global and local SA/SAW supporting decision speed for both operators and authority. The management, orchestration, and interpretation of this information space, often injected with deception and environmental attenuation, has obscured for (near) real-time decision processes and systems capability optimization resulting in imminent costs and loss of life. A key scientific factor contributing to these digital model needs is the lack of exploitation in degree of freedom (DOF) spaces that raw collected data and their fusion manifolds possess. These structures are rich, alternative sources of intrinsic mathematical properties where paradigm shifts in local/global SA (i.e., machine analytics) and SAW (i.e., systems awareness) could be instantiated. Topological structure, either inherent or easily introducible to any data modality, encodes, measures, and tracks the static/dynamic characteristics/evolution of these DOF spaces. Topological data analysis (TDA) with its numerous recent successes in a broad range of scientific disciplines and applications inside the military and out forecast its utility as a scalable, generalizable means to leverage these topologies. TDA supplies rigorous mathematical, statistical, and efficient algorithmic methods that produce meaningful analytics when applied to topological and geometric structures of significant complexity by measuring, recording, and tracking linear representations of an underlying data set. The workhorse and most successful of these methodologies is persistent homology (PH). PH is a data compression scheme quantifying critical points of continuous spaces and addressing more general notions of multi-scale characteristics, high-dimensional features, and abstract data structures with the use of discrete metrics.

All the varying modalities of sensor data generated in contested environments (e.g., densely populated urban environments, terrestrial/celestial theatres of tactical/strategic interest. etc.) possess an intrinsic mathematical structure measured, tracked, recorded, and described precisely through its inherent, or an easily introducible, topology. The TDA AI/ML pipeline or TDAML is an algorithm which exploits the topological characteristics of raw sensor data through rigorous embeddings and metrics to produce implementable feature engineering which readily interfaces with various state of the art AI/ML deep learning (DL) architectures (e.g., DNN, CNN, RNN(LSTM), Evidential Neural Networks, (variational) AEs, GANs, other generalized transformer models, etc.). Within contested environments, the TDAML improves predictive performance in, for example, autonomous target recognition (ATR) tasks, reduces data volumes by several orders of magnitude with little to no degradation in probability of detection, and offers a scalable scaffold for the data fusion of disparate modalities.

The challenges to data fusion capable of being ingested into existing DL model architectures, exploiting raw multimodal sensor data's entire DOF space and deployable autonomy solutions mitigated by TDAML include the heterogeneity of multimodal data sources and reliance on specified derived data analytics for AI/ML modeling solutions.

Data fusion: TDAML provides a means to combine heterogeneous raw multimodal sensor data at the topological level providing a linear representation which is compatible to existing DL model architectures.

Leveraging the raw multimodal sensor data and its fusion aggregates entire DOF space: TDAML provides a means to access the entire DOF space of raw multimodal sensor data and use their data fusion manifolds to mitigate single sensor modality adversarial threats and environmental attenuation concerns in contested military and civilian (urban) environments.

Deployable Autonomy: through TDA/topology's ability for data compression in its feature space engineering reduced order modeling for trained DL models occurs allowing for a broader range of applicability for the user community in edge based and collaborative system in situ methodologies.

Methodology: To the best of our knowledge, there is no prior work within applications to raw multimodal sensor data TDA based feature engineering for feature engineering and data fusion at the topological level in autonomy for raw multimodal sensor data in the current literature. There are several reasons for this disparity: 1) the heterogeneity of raw multimodal data sources. For example, full motion video pixelated imagery data and non-linear time series data such as radio waves of varying sample frequencies along with environmental attenuation make the robust analytics and discovery of repeatable data fusion methods challenging or intractable. This prohibits the discovery of a natural synergy between disparate raw sensor modalities at the linear level mathematically to allow ingestion into deep learning (DL) architectures for training purposes. 2) Several of the calculations TDA depend on require significant compute resources to resolve when applied to real world (or measured) multimodal sensor data with attenuation characteristics such as parallax or scattering. These principally include the construction of the simplicial filtration and homological analysis central to persistent homology as well as the embedding process for time-series data. Modern advances in compute capacity through distributive/cloud-based means have allowed for these real world analytics but prohibited there development even 5 years ago.

Due to the above challenges in raw multimodal sensor data fusion and methodologies to generate ingestible feature spaces to train existing DL models, a novel solution to combat these challenges and achieve various autonomy objectives would include multidimensional data, deep learning techniques, and an interpretable feature space engineering at scale.

Given the foregoing challenges, examples according to the present disclosure provide a topologically informed neural network architecture, the TDAML, which ingests arbitrary raw multimodal data for deep learning applications in autonomy decision processes involving user SA/SAW. This new approach endeavors to achieve the following three objectives: (1) Data efficiency that reduces real-world volumes of data to a compact set of information (i.e., a “topological fingerprint” or “topological signal”) for classification and prediction tasks; (2) Computing Efficiency that constrains the processing of the CPU/RAM/GPU demands to local device level compute power for users leveraging laptop or cellphone platforms; (3) a Deployable system that is equipped with the proper data and computing efficiency, affording lightweight, agile operability on a mobile device such as a laptop or cellphone.

The embodiments herein provide a TDAML system that is based on analyzing ingested raw data of one or more deployed sensor modalities yielding, for example, reliable automatic target recognition (ATR) for a specified domain. Topological Data Analysis (TDA) refers to extracting and assigning a unique vector valued “topological signal” based on the topology of a sampled raw sensor modality/modalities and their data fusion aggregate to said targets in the specified domain. A data fusion aggregate or manifold refers to a collective linear space of one or more than one raw sensor data modality, its total number of devices, and total number of channels in said devices. These fusion manifolds are organized by entrywise concatenation based on the minimal sample frequency of the given sensor modality collection. The resulting topological signals are then ingested into a machine learning algorithm for the training of models in classification tasks for one or more objects. This capability can play an important role in intelligence, surveillance, and reconnaissance for decision speed support in various target domains as well as object detection/avoidance and collision mitigation in autonomous vehicles. For example, the use of the TDAML has been validated with near perfect probability of detection for ATR in trained models on measured data from small uncrewed aerial systems (SUAS), ground vehicles and ground personnel (or dismounts) involving acoustic, electro-optical (EO), infrared (IR) sensor data modalities as well as their data fusion manifolds.

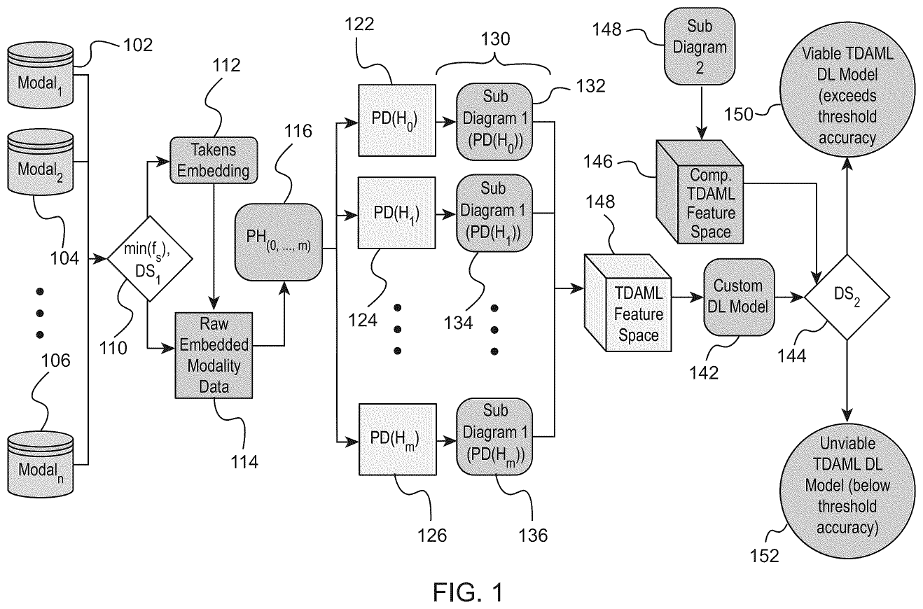

Referring now to the drawings, and more particularly to FIGS. 1 through 3, there are shown exemplary embodiments where similar reference characters denote corresponding features consistently throughout. In the drawings, the size and relative sizes of components, layers, regions, etc. may be exaggerated for clarity.

The various modules and corresponding components described herein and/or illustrated in the figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, and database components. For example, the data objects could include a digital packet of structured data. Example data structures may include any of an array, tuple, map, union, variant, set, graph, tree, node, or object, which may be stored and retrieved by computer memory and may be managed by processors. compilers, and other computer hardware components. The data paths can be part of a computer CPU or GPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. The database components can include any of the tables, indexes, views, stored procedures, and triggers.

Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. The embodiments herein can include both hardware and software elements. The embodiments that are implemented in software include but are not limited to, firmware, resident software, microcode, etc.

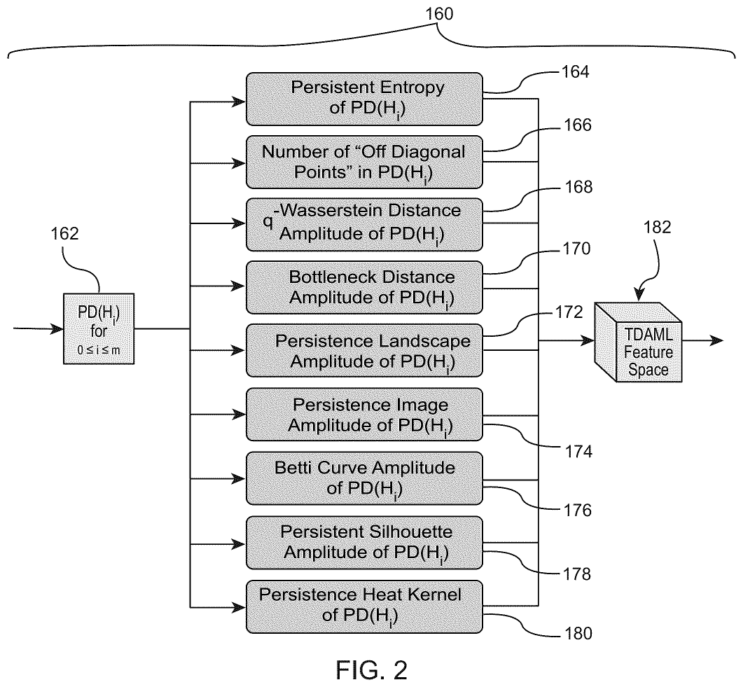

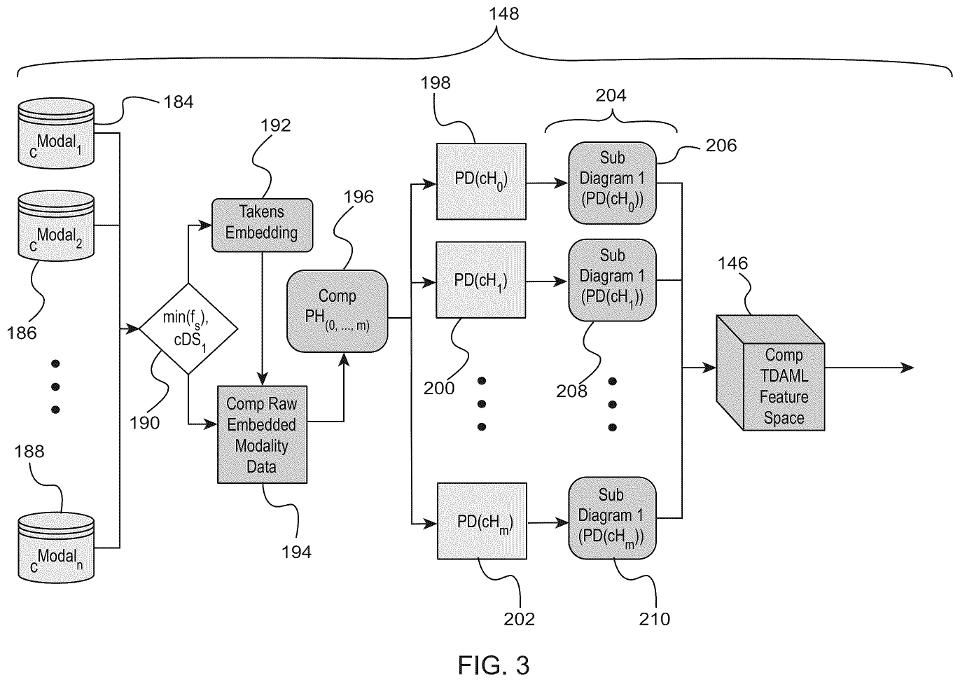

FIG. 1 is a block diagram illustrating from left to right a TDAML embodiment where blue indicates data structures (either source data or internal data to the TDAML embodiment), red indicates TDAML functional module, and yellow indicates a TDAML decision structure module. On the leftmost of FIG. 1, finitely many (i.e., “n” many where n is a positive integer; n∈{1, 2, 3, . . . } or n∈ [symbol] ₊) sensor data modality source components labeled Modal₁ 102, Modal₂ 104, . . . , Modalₙ 106 store the raw multimodal input data. Each source component in this collection, Modalᵢ, where 1≤i≤n, may contain k∈ [symbol] ₊ possible contributing devices with p∈ [symbol] ₊ possible channels in each device of the same sensor modality. In some examples, the memory involved in Modal₁ 102, Modal₂ 104, . . . , Modalₙ 106 may be Random Access Memory, Read-Only Memory, cache memory, hard drive storage, flash memory, the cloud, or other type of storage mechanisms. Furthermore, the memory of Modal₁ 102, Modal₂ 104, . . . , Modalₙ 106 may be part of a server computer system or electronic device (not shown) that is remotely linked to Modal₁ 102, Modal₂ 104, . . . , Modalₙ 106 through any wired and wireless communication, according to an example. The memory content of Modal₁ 102, Modal₂ 104, . . . , Modalₙ 106 will ingest into the first decision structure, DS₁ 110, where each Modalᵢ's sample frequency is Hertz (Hz) valued and sorted until a minimum sample frequency, min(fₛ), is identified from file metadata for the entire Modalᵢ collection. Then min(fₛ) is stored for compatible sample size decomposition in the TDAML's Takens Embedding 112 functional module and for the organization of the Raw Embedded Modality Data 114 data structure. For example, if Modal₁ 102=30 Hz and Modal₂ 104=48000 Hz (or 48 kHz) in the ingested set {Modal₁ 102, Modal₂ 104} then the min(fₛ)=30 Hz and the higher frequency, Modal₂ 104=48000 Hz, would be decomposed into 1/30th second subsamples each containing 1600 sampled measurements. Next, in DS₁ 110, each ingested Modalᵢ is determined to be either time-series data (e.g., acoustic, radio frequency, or seismic modalities in .wav, .bin, or other file formats) or static data (e.g., single frames of full motion video in EO or IR modalities represented as pixels, point cloud data, or features in .mp4, MOV, or other file formats). In the former case, Modalᵢ is passed to the Takens Embedding 112 functional module. From a given time series f(t) sample frequency one can produce a Takens embedding with embedding dimension D and time delay τ as a sequence of vectors fᵢ=(f(tᵢ), f(tᵢ+τ), f(tᵢ+2t), . . . , f(tᵢ+(D−1)τt))⊂ [symbol] ^{D}. The Takens Embedding 112 functional module produces an optimized finite dimensional Euclidean space topologically equivalent to the corresponding time-series data's dynamical system of origin. This space is then stored in the Raw Embedded Modality Data 114 data structure module and stored as .csv, .mat, or other file format. In the latter case the static data is passed directly to the Raw Embedded Modality Data 114 data structure module and stored as .csv, .mat, or other matching file formats to the former case. The Raw Embedded Modality Data 114 module's files then pass sequentially to the persistence homology module, PH_{(0,1,2, . . . ,m)} 116={PH₀, PH₁, . . . , PHₘ}={H₀, H₁, . . . , Hₘ} where each Raw Embedded Modality Data 114 module file is processed for m∈ [symbol] ₊ dimensions of persistent homology (PH) producing a persistence diagram (PD) in the corresponding PH dimension. For example, the 0^{th} PH dimension, H₀, of each Raw Embedded Modality Data 114 module's file is stored in the persistence diagram data structure module, PD(H₀) 122, as a .csv, .mat, .npy, .json, h5, .xlsx, .txt or similar file format, the 1^{st} PH dimension, H₁, of each Raw Embedded Modality Data 114 module's file is stored in the PD(H₁) 124 data structure module as a .csv, .mat, .npy, .json, .xlsx, .txt or similar file format, . . . , the m^{th} persistent homology dimension, Hₘ, of each Raw Embedded Modality Data 114 module's file is stored in the PD(Hₘ) 126 data structure module as a .csv, .mat, .npy, .json, .xlsx, .txt or similar file format. Next, each of the PD(Hᵢ) modules, where 0≤i≤m, is then ingested into its corresponding Sub Diagram 1(PD(Hᵢ)) module to its immediate right in FIG. 1. For example, the 0^{th} dimensional persistence diagram data structure module, PD(H₀) 122, is ingested into the Sub Diagram 1(PD(H₀)) 132 functional module, detailed in FIG. 2, where each 0^{th} dimensional PD in PD(H₀) 122 is processed for its 9 topological metrics and stored as a 9 dimensional real valued vectors in the TDAML Feature Space 140 data structure as a csv, .mat, .npy, .json, h5, .xlsx, .txt or similar file format, the 1^{st} dimensional persistence diagram data structure module, PD(H₁) 124, is ingested into the Sub Diagram 1(PD(H₁)) 134 functional module, detailed in FIG. 2, where each 1^{st} dimensional PD in PD(H₁) 124 is processed for its 9 topological metrics and stored as a 9 dimensional real valued vectors in the TDAML Feature Space 140 data structure as a csv, .mat, .npy, .json, h5, .xlsx, .txt or similar file format, . . . , the m^{th} dimensional persistence diagram data structure module, PD(Hₘ) 126, is ingested into the Sub Diagram 1(PD(Hₘ)) 136 functional module, detailed in FIG. 2, where each 1^{st} dimensional PD in PD(Hₘ) 126 is processed for its 9 topological metrics and stored as a 9 dimensional real valued vectors in the TDAML Feature Space 140 data structure as a .csv, .mat, .txt, or similar file format. The TDAML Feature Space 140 data structure is organized such that every data sample from Modalᵢ, where 1≤i≤n and whose the number of samples is based on min(fₛ), is a row (height) of a two dimensional (2D) array representing that Modalᵢ and each dimension of PH processed as its corresponding PD for said 9 topological metrics is a column (width) of a two dimensional (2D) array representing that Modalᵢ. These 2D arrays have size (height, width)=(# of samples based on min(fₛ), 9(m+1)). In turn, these 2D arrays are then aligned entrywise for each Modalᵢ (which may possibly contain k∈ [symbol] ₊ contributing devices with p∈ [symbol] ₊ possible channels) concatenating the entrywise components in each 2D array into vectors of a 3D array whose depth has size nkp. In summary, the TDAML Feature Space 140 data structure stored as a csv, .mat, .npy, .json, h5, .xlsx, .txt or similar file format is a 3D array of said 9 topological features with size (height, width, depth)=(# of samples based on min(fₛ), 9(m+1), nkp). Next, the TDAML Feature Space 140 data structure is ingested into the Custom DL Model 142 functional module as a feature space for training Deep Leaning (DL) models of various types (Deep Neural Networks or DNNs, Convolutional Neural Networks or CNNs, transformer models, etc). For example, the Custom DL Model 142 could be a fully connected DNN with several hidden layers containing several thousand trainable parameters trained with a random train/test split (e.g., an 80/20, 70/30, etc. type train/test split) on supervised learning for binary/multi-classification of one or more mobile targets in a designated domain. This DNN would be trained over finitely many epochs until accuracy in prediction of said target is (near) perfect and the loss function is near 0. This may require modifications to hyperparameters and architecture of the Custom DL Model 142 with user-on-the-loop methodologies to obtain these results. This trained TDAML DL model's data structure is then stored in the decision structure functional module, DS₂ 144, as a .csv, .npy, .json, h5, .parquet, .orc, .avro, .petastorm, .tfrecords, .json, .xlsx, etc. or similar file format. As part of the DS₂ 144, said trained DL model can either be validated on test data from the original train/test split or on a comparative TDA feature space data structure test set (the Comp TDAML Feature Space 146) of identical dimensions and equal size built using Sub Diagram 2 148 and detailed in FIG. 3. Finally, from DS₂ 144 the validated model based on a prescribed prediction accuracy threshold (e.g., an accuracy >90%) is stored in the Viable TDAML DL Model (exceeds threshold accuracy) 150 functional model waiting for its user call for deployment. Otherwise, the TDAML DL model goes to the Unviable TDAML DL Model (below threshold accuracy) 152 where it can be analyzed for improvement and future use cases.

FIG. 2, with reference to FIG. 1, is a block diagram for TDAML representing an embodiment of the TDAML algorithm entitled Sub Diagram 1 130 functional module in the block diagram of FIG. 1. It contains a description of the Sub Diagram 1 130 functional module's 9 topological metrics as they are applied to each PD(Hᵢ) 162, where 0≤i≤m and m is the prescribed number of dimensions of persistent homology, ingested into it. Those 9 topological metrics: 1) Persistent Entropy (PE) 164, 2) Number of “Off Diagonal” Points (NoP) 166, 3) the Bottleneck Distance Amplitude (Btl) 168, 4) the q-Wasserstien Distance Amplitude (Wass) 170, 5) The Persistence Landscape Amplitude (PL) 172, 6) the Persistence Image Amplitude (PI) 174, 7) the Betti Curve Amplitude (Bet) 176, 8) the Persistence Silhouette Amplitude (Sil) 178, and 9) the Persistence Heat Kernel (Heat) 180. They are summarized in the provided Table 1 with their associated governing equation and output type (mostly real numbers or “ [symbol] -valued scalars”; recall that [symbol] _{≥0} is all non-negative integers) to aid in FIG. 2's description. Although commercial off the shelf software is utilized in the TDAML's construction, the synthesis of employing all 9 topological metrics for use on raw multimodal sensor data for autonomous applications such as target recognition is completely novel.

TABLE 1

| Topological | | |
|---|---|---|
| Metric | Governing Equation | Output |
| Persistent Entropy (PE) 164 | $E ( F ) = - {\sum }_{i = 1}^{n} {p}_{i} log ( {p}_{i} ) \text{(*} )$ | [symbol] - valued scalar |
| Number of | # of points by dimension of persistent | [symbol] - |
| “Off Diagonal | homology (PH) | valued |
| Points” (NoP) | | scalar |
| 166 | | |
| Bottleneck | ${d}_{B} ( P , Q ) = {inf}_{M : P \to Q} c ( M )$ | [symbol] - |
| Distance | where c(M) is the cost function | valued |
| Amplitude | between all partial matches M (**) | scalar |
| (Btl) 170 | | |
| q-Wasserstein Distance Amp. (Wass) 168 | ${W}_{q} ( P , Q ) = {( {inf}_{M : P \to Q} {\sum }_{p ∈ P} {‖ p - M ( p ) ‖}_{∞}^{q} )}^{1 / q} \text{(*} \text{*)}$ | [symbol] - valued scalar |
| Persistence Landscape Amp. (PL) 172 | ${‖ λ - {λ}^{′} ‖}_{2} = {[ {\sum }_{k = 1}^{N} \int \vert {λ}_{k} ( x ) - {λ}_{k}^{′} ( x ) {\vert}^{2} dx ]}^{\frac{1}{2}} ( ° )$ | [symbol] - valued scalar |
| Persistence Image Amp. (PI) 174 | ${‖ λ - {λ}^{′} ‖}_{2} = {[ {\sum }_{k = 1}^{N} \int {\vert {λ}_{k} ( x ) - {λ}_{k}^{′} ( x ) \vert}^{2} dx ]}^{\frac{1}{2}} ( ° )$ | [symbol] - valued scalar |
| Betti Curve Amp. (Bet) 176 | ${‖ {Π}_{p} ‖}_{2} = {( {\sum }_{k = 1}^{N} \int {\vert {Π}_{p} ( x ) \vert}_{k}^{2} dx )}^{1 / 2} ( ° )$ | [symbol] - valued scalar |
| Persistence Silhouette Amp. (Sil) 178 | ${‖ λ - {λ}^{′} ‖}_{2} = {[ {\sum }_{k = 1}^{N} \int {\vert {λ}_{k} ( x ) - {λ}_{k}^{′} ( x ) \vert}^{2} dx ]}^{\frac{1}{2}} ( ° )$ | [symbol] - valued scalar |
| Heat Kernel Amplitude. 180 | ${κ}_{σ} ( P , Q ) = {〈 {ϕ}_{σ} ( P ) , {ϕ}_{σ} ( Q ) 〉}_{L}^{2} ( Ω ) , {‖ λ - {λ}^{′} ‖}_{2} = {( {\sum }_{k = 1}^{N} \int {\vert {λ}_{k} ( x ) - {λ}_{k}^{′} ( x ) \vert}_{k}^{2} dx )}^{\frac{1}{2}} ( °° )$ | [symbol] - valued scalar |

A Summary of the 9 Topological Metrics, Their Respective Governing Equations, and Numerical Output Type in FIG. 2 of Sub Diagram 1 160 Contained as a Functional Module in the TDAML in FIG. 1.
* For a given filtration F and its corresponding PD, dgm(F) = {bᵢ, dᵢ)| 1 ≤ i ≤ n} where bᵢ < dᵢ for all i, let [symbol] = {dᵢ − bᵢ| 1 ≤ i ≤ n}, pᵢ = [symbol] ᵢ/S_{L}, [symbol] ᵢ = dᵢ − bᵢ and S_{L} = Σᵢ₌₁ⁿ [symbol] ᵢ.** Let P and Q be PDs where P = {(bᵢ, dᵢ)|dᵢ > bᵢ ≥ 0, i = 0, 1, . . . , n} and Q = {(bᵢ′, dᵢⁱ)|dᵢ′ > bᵢ′ ≥ 0}, i = 0,1, . . . , m. A partial match between P and Q is a bijection M between a subset P and Q. Define the L_{∞} norm between a (b, d) ∈ P and (b′, d′) ∈ Q by ∥p − q∥_{∞} = max {|b − b′|, |d − d′|} with p, q ∈ [symbol] .
° ||•||₂ is the standard L² norm from the PL/PI/Bet/Sil of interest . to the trivial (or empty) PL/PI/Bet/Sil λ′.° ° Persistent heat kernel K_{σ}; For PD diagrams P and Q in the space of all PDs D, Ω = x = {(x₁, x₂) ∈ [symbol] ² |x₂ ≥ x₁,}, and σ > 0, define a feature map ϕ_{σ}, : D → L² (Ω).
$The the closed form heat equation {κ}_{σ} ( P , Q ) = \frac{1}{8 πσ} {\sum }_{p ∈ P , q ∈ Q} {e}^{- \frac{{‖ p - q ‖}^{2}}{8 σ}} - {e}^{- \frac{{‖ p - q ‖}^{2}}{8 σ}} ; {‖ \cdot ‖}_{2} is the$ standard L² norm from the persistent heat kernel of interest λ to the trivial (or empty) persistent heat kernel λ′.

As seen in the leftmost portion of the block diagram in FIG. 2, depicted in FIG. 1, and described above, each of the PD(Hᵢ) data structure modules, where 0≤i≤m is the associated PH dimension, ingest into its corresponding Sub Diagram 1 (PD(Hᵢ)) module. As shown in the block diagram of FIG. 2, each Sub Diagram 1 (PD(Hᵢ)) module consists of 9 topological feature functional submodules, namely the Persistent Entropy of PD(Hᵢ) 164 or PE(Hᵢ) submodule, the Number of ‘Off Diagonal Points’ in PD(Hᵢ) 166 or NoP(Hᵢ) submodule, the q-Wasserstein Distance Amplitude of PD(Hᵢ) 168 or Wass(Hᵢ) submodule, the Bottleneck Distance Amplitude of PD(Hᵢ) 170 or Btl(Hᵢ) submodule, the Persistence Landscape Amplitude of PD(Hᵢ) 172 or PL(Hᵢ) submodule, the Persistence Image Amplitude of PD(Hᵢ) 174 or PI(Hᵢ) submodule, the Betti Curve Amplitude of PD(Hᵢ) 176 or Bet(Hᵢ) submodule, the Persistence Silhouette Amplitude of PD(Hᵢ) 178 or Sil(Hᵢ) submodule, and the Persistence Heat Kernel of PD(Hᵢ) 180 or Heat(Hᵢ) submodule. Each of the listed 9 submodules ingests each PD(Hᵢ) individually computing that particular topological metric using the associated governing equation in Table 1 and produces a real or integer valued output. These outputs which are collected in the TDAML Feature Space 182 data structure and organized as described above. For example, PE(H₀) ingests each 0^{th}dimensional PH associated persistence diagram data structure, PD(H₀), in csv, .mat, .npy, .json, .xlsx, .txt or similar file format, calculates the PE of each PD(H₀) utilizing the governing equation shown in row 1 of Table 1, namely E(F)=−Σᵢ₌₁ⁿpᵢ log(pᵢ) (For a given filtration F and its corresponding PD, dgm(F)={bᵢ,dᵢ)|1≤i≤n} where bᵢ<dᵢ for all i, let [symbol] ={dᵢ−bᵢ|1≤i≤n}, pᵢ= [symbol] ᵢ/S_{L}, [symbol] ᵢ=dᵢ−bᵢ and S_{L}=Σᵢ₌₁ⁿ [symbol] ᵢ), outputs a real number PE measurement value of its corresponding PD(H₀). This PE value “sequentially populates” an entry in the PE(H₀) column vector for every ingested PD(H₀). By sequentially populating a vector we mean that the first ingested PD(H₀) becomes the first entry in the column vector, the second ingested PD(H₀) becomes the second entry in the column vector, etc. An analogous process is done for all 0, 1, 2, . . . , m PH dimensions yielding m+1 PE(Hⱼ), 0≤j≤m, real-valued column vectors of length=# of samples based on min(fₛ) for every Modalᵢ, where 1≤i≤nkp is the number of sensor modalities/devices/channels ingested. The described PE(H₀) submodule process is analogous and concurrently occurs in the Wass(Hᵢ) 168 submodule, the Btl(Hᵢ) 170 submodule, the PL(Hᵢ) 172 submodule, the PI(Hᵢ) 174 submodule, the Bet(Hᵢ) 176 submodule, the Sil(Hᵢ) 178 submodule, and Heat(Hᵢ) 180 submodule. In the NoP(Hᵢ) 166 submodule the concurrent processing is also identical except that the number of points in each PD(Hᵢ) 164 representing a i^{th} dimension of PH is counted yielding a non-negative integer value which sequentially populates an entry in the NoP(Hᵢ) 166 column vector for every ingested NoP(Hᵢ) 166. Just as with the PE(H₀) process descriptions all these outputs are collected in the TDAML Feature Space 182 data structure and organized as described above.

FIG. 3, with reference to FIG. 1, is a block diagram for TDAML representing the embodiment of the TDAML algorithm entitled the Sub Diagram 2 148 functional module in the block diagram of FIG. 1. It follows a very similar workflow of FIG. 1's block diagram but terminates when it produces a comparative TDAML feature space, Comp TDAML Feature Space 146 data structure, of equal dimension and organization to its FIG. 1 counterpart, TDAML Feature Space 140. The Comp TDAML Feature Space 146 data structure can be used as an alternative validation set based for the trained DL model outputted from the Custom DL Model 142 functional module in FIG. 1's block diagram stored in its decision structure module DS₂ 144. For example, if the TDAML was used for autonomous classification of a target/s, the TDAML Feature Space 140 would train a DL model at a distinct timestamp/s for the given sensor modality/modalities on the given target/s and the Comp TDAML Feature Space 146 build would occur at a second distinct target/s timestamp/s for sensor modality/modalities yielding a validation set for the trained DL model stored in FIG. 1's block diagram decision structure DS₂ 144. The validation on Comp TDAML Feature Space 146 would then push said DL model to the Viable TDAML DL Model (exceeds threshold accuracy) 150 or Unviable TDAML DL Model (below threshold accuracy) 152 modules described above.

The block diagram in FIG. 3 illustrated from left to right is an embodiment of the Sub Diagram 2 148 functional module in the block diagram of FIG. 1 where blue indicates data structures (either source data or internal data to the Sub Diagram 2 148 embodiment), red indicates a TDAML functional module, and yellow indicates a TDAML decision structure module. On the leftmost of FIG. 3, finitely many (i.e., “n” many where n is a positive integer; n∈{1, 2, 3, . . . } or n∈ [symbol] ₊) comparative sensor data modality source components labeled cModal₁ 184, cModal₂ 186, . . . , cModalₙ 188 store the raw multimodal input data. Each source component in this collection, cModalᵢ, where 1≤i≤n, may contain k∈ [symbol] ₊ possible contributing devices with p∈ [symbol] ₊ possible channels in each device of the same sensor modality. In some examples, the memory involved in cModal₁ 184, cModal₂ 186, . . . , cModalₙ 188 may be Random Access Memory, Read-Only Memory, cache memory, hard drive storage, flash memory, the cloud, or other type of storage mechanisms. Furthermore, the memory of cModal₁ 184, cModal₂ 186, . . . , cModalₙ 188 may be part of a server computer system or electronic device (not shown) that is remotely linked to cModal₁ 184, cModal₂ 186, . . . , cModalₙ 188 through any wired and wireless communication, according to an example. The memory content of cModal₁ 184, cModal₂ 186, . . . , cModalₙ 188 will ingest into the first decision structure, cDS₁ 190, where each cModalᵢ sample frequency is Hertz (Hz) valued and sorted until a minimum sample frequency, min (fₛ), is identified from file metadata for the entire given cModalᵢ. This “comparative” min(fₛ) is equal to the min(fₛ) identified in the analysis for the block diagram in FIG. 1 since we are comparing the same multimodal sensor collection to the original. Then min(fₛ) is stored for compatible sample size decomposition in the Takens Embedding 192 functional module and organization of the Comp Raw Embedded Modality Data 194 data structure in the block diagram of FIG. 3. For example, if cModal₁ 184=30 Hz and cModal₂ 186=48000 Hz (or 48 kHz) in the ingested set {cModal₁ 184, cModal₂ 186} then the min(fₛ)=30 Hz and the higher frequency. cModal₂ 186=48000 Hz, would be decomposed into 1/30th second subsamples each containing 1600 sampled measurements. Next, in cDS₁ 190, each ingested cModalᵢ is determined to be either time-series data (e.g., acoustic, radio frequency, or seismic modalities in .wav, .bin, or other file formats) or static data (e.g., single frames of full motion video in EO or IR modalities represented as pixels, point cloud data, or features in .mp4, MOV, or other file formats). In the former case, cModalᵢ is passed to the Takens Embedding 192 functional module of the Sub Diagram 2 148 embodiment producing an optimized finite dimensional Euclidean space topologically equivalent to the corresponding time-series data's dynamic system of origin and stored in the comparative or Comp Raw Embedded Modality Data 194 data structure module and stored as .csv, .mat, or other file formats. Recall from a given time series f(t) sample data one can produce a Takens embedding with embedding dimension D and time delay τ as a sequence of vectors fᵢ=(f(tᵢ), f(tᵢ+τ), f(tᵢ+2τ), . . . , f(tᵢ+(D−1)τ))⊂ [symbol] ^{D} (see [1] for full details of this embedding). In the latter case the static data is passed directly to the Comp Raw Embedded Modality Data 194 data structure module and stored as .csv, .mat, or other matching file formats to the former case. The Comp Raw Embedded Modality Data 194 module's files then pass sequentially to the comparative persistence homology module, Comp PH_{(0,1,2, . . . ,m}) 196={cPH₀, cPH₁, . . . , cPHₘ}={cH₀, cH₁, . . . , cHₘ} where each Comp Raw Embedded Modality Data 194 module file is processed for m E∈ [symbol] ₊ dimensions of persistent homology (PH) producing a persistence diagram (PD) in the corresponding PH dimension. For example, the 0^{th} PH dimension, cH₀, of each Comp Raw Embedded Modality Data 194 module's file is stored in the persistence diagram data structure module, PD(cH₀) 198, as a .csv, .mat, .npy, .json, h5, .xlsx, .txt or similar file format, the 1^{st} PH dimension, cH₁, of each Comp Raw Embedded Modality Data 194 module's file is stored in the PD(cH₁) 200 data structure module as a .csv, .mat, .npy, .json, .xlsx, .txt or similar file format, . . . , the m^{th} persistent homology dimension, cHₘ, of each Comp Raw Embedded Modality Data 194 module's file is stored in the PD(cHₘ) 202 data structure module as a .csv, .mat, .npy, .json, .xlsx, .txt or similar file format. Next, each of the PD(cHᵢ) modules, where 0≤i≤m, is then ingested into its corresponding Sub Diagram 1(PD(cHᵢ)) module to its immediate right in FIG. 3. In all respects the Sub Diagram 1(PD(cHᵢ)) 240 module collection of FIG. 3 processes identically to the Sub Diagram 1 160 workflow detailed in FIG. 2 except that the Sub Diagram 1(PD(cHᵢ)) 240 module collection ingests the PD(cHᵢ) modules for each i as shown in FIG. 3. For example, the 0^{th} dimensional persistence diagram data structure module, PD(cH₀) 198, is ingested into the Sub Diagram 1(PD(cH₀)) 206 functional module, detailed in FIG. 2, where each 0^{th} dimensional PD in PD(cH₀) 198 is processed for its 9 topological metrics and stored as a 9 dimensional real valued vectors in the Comp TDAML Feature Space 194 data structure as a csv, .mat, .npy, .json, h5, .xlsx, .txt or similar file format, the 1^{st} dimensional persistence diagram data structure module, PD(cH₁) 200, is ingested into the Sub Diagram 1(PD(cH₁)) 208 functional module, detailed in FIG. 2, where each 1^{st} dimensional PD in PD(cH₀) 198 is processed for its 9 topological metrics and stored as a 9 dimensional real valued vectors in the Comp TDAML Feature Space 194 data structure as a csv, .mat, .npy, .json, h5, .xlsx, .txt or similar file format, . . . , the m^{th} dimensional persistence diagram data structure module, PD(cHₘ) 202, is ingested into the Sub Diagram 1(PD(cHₘ)) 210 functional module, detailed in FIG. 2, where each 1^{st} dimensional PD in PD(cH₀) 198 is processed for its 9 topological metrics and stored as a 9 dimensional real valued vectors in the Comp TDAML Feature Space 146 data structure as a .csv, .mat, .txt, or similar file format. The Comp TDAML Feature Space 146 data structure is organized such that every data sample from cModalᵢ, where 1≤i≤n and whose the number of samples is based on min(fₛ), is a row (height) of a two dimensional (2D) array representing that cModalᵢ and each dimension of PH processed as its corresponding PD for said 9 topological metrics is a column (width) of a two dimensional (2D) array representing that cModalᵢ. These 2D arrays have size (height, width)=(# of samples based on min(fₛ), 9(m+1)). In turn, these 2D arrays are then aligned entrywise for each cModalᵢ (which may possibly contain k∈ [symbol] ₊ contributing devices with p∈ [symbol] ₊ possible channels) concatenating the entrywise components in each 2D array into vectors of a 3D array whose depth has size nkp. In summary, the Comp TDAML Feature Space 146 data structure stored as a csv, .mat, .npy, .json, h5, .xlsx, .txt or similar file format is a 3D array of said 9 topological features with size (height, width, depth)=(# of samples based on min(fₛ), 9(m+1), nkp). Finally, the Comp TDAML Feature Space 146 data structure is ingested into the decision structure module DS₂ 144 in the block diagram of FIG. 1, the DL model produced in FIG. 1 is validated against a randomly selected Comp TDAML Feature Space 146 test set, and moves to either Viable TDAML DL Model (exceeds threshold accuracy) 150 or Unviable TDAML DL Model (below threshold accuracy) 152 modules described above.

The embodiments herein extend the concept of information extraction from raw multimodal data sensor sources by providing a topology-based time series and imagery information extraction system that is based on ground truths generated by multimodal sensors for a specific target domain. This capability can play an important role in multimodal sensor data fusion analytics for various target domains. For example, it is relevant for autonomy in target recognition applications such as identification/information exploitation of adversarial assets and their deployments in military theatres under contested/deceptive environments or for object detection through imagery as well as emitter data in commercial vehicles for avoidance and collision mitigation.

All the varying modalities of sensor data generated in contested environments (densely populated urban environments, terrestrial/celestial theatres of tactical/strategic interest, etc.) possess an intrinsic mathematical structure measured, tracked, recorded, and described precisely through its inherent, or an easily introducible, topology. The topological data analysis (TDA) AI/ML pipeline (TDAML) is an algorithm which exploits the topological characteristics of the sensor data through rigorous embeddings and metrics to produce implementable feature engineering which readily interfaces with various state of the art AI/ML workflows (e.g., DNN, CNN, RNN(LSTM), Evidential Neural Networks, (variational) AEs, GANs, other generalized transformer models, etc.). Within contested environments, the TDAML improves predictive performance in autonomous target recognition (ATR) tasks, reduces data volumes by several orders of magnitude with little to no degradation in probability of detection, and offers a scalable scaffold for the data fusion of disparate modalities.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method of topological data analysis feature engineering for data fusion and autonomy comprising:
providing a Topological Data Analysis AI/ML Pipeline (TDAML) algorithm for multimodal sensor data fusion in an autonomy applications system further comprising:
combining raw heterogeneous multimodal sensor data at the topological level;
measuring, recording, and tracking linear representations of an underlying data set;
providing a linear representation of the underlying data set which is compatible to existing deep learning (DL) model architectures for training in autonomy tasks; and
accessing the entire degree of freedom (DOF) space of raw multimodal sensor data for mitigating sensor modality adversarial threats and environmental attenuation concerns in contested military and civilian (urban) environments.

2. The method of claim 1, further comprising constructing raw multimodal sensor data fusion manifolds.

3. The method of claim 2 wherein the raw multimodal sensor data fusion manifolds are a topological fingerprint and an avenue to the characteristics of the entire DOF space of the manifolds for mitigating at least one of single sensor modality adversarial threats, environmental attenuation concerns, classification tasks in autonomy, and predictive tasks in system health monitoring in contested military and commercial environments.

4. The method of claim 3 wherein the TDAML produced topological feature space precipitates reduced order modeling in existing DL model architectures contributing directly to its increased use in mobile computing platform applications and distributed analytical systems.

5. The method of claim 4 further comprising providing dynamic information in target recognition applications for collective deployments of small uncrewed aerial/maritime systems, ground vehicles, and ground personnel including by at least one of object detection through imagery and emitter data in commercial vehicles for avoidance and collision mitigation.

6. The method of claim 1 wherein the raw heterogeneous multimodal sensor data includes one or more sensor data modality source components to store raw multimodal input data with each source component identified containing finitely many contributing devices with finitely many possible channels in each device of the same sensor modality.

7. The method of claim 6 further comprising a memory content ingesting one or more modalities into a corresponding decision structure, wherein each modality's sample frequency is Hertz valued and sorted until a minimum sample frequency is identified from file metadata for the entire modality collection.

8. The method of claim 7 further comprising storing the minimum sample frequency for compatible sample size decomposition in a Takens Embedding functional module and for the organization of a Raw Embedded Modality Data data structure.

9. The method of claim 8 further comprising determining each ingested modality to be either time-series data or static data.

10. The method of claim 9 further comprising passing a time-series data modality to the Takens Embedding functional module which, from a given time series f(t) sample frequency producing a Takens embedding with embedding dimension D and time delay τ as a sequence of vectors fᵢ=(f(tᵢ), f(tᵢ+τ), f(tᵢ+2τ), . . . , f(tᵢ+(D−1)τ))⊂ [symbol] ^{D}, and producing an optimized finite dimensional Euclidean space topologically equivalent to the corresponding time-series data's dynamic system of origin and storing in the Raw Embedded Modality Structure data structure module and passing a static data directly to the Raw Embedded Modality Data data structure module.

11. The method of claim 10 further comprising processing each Raw Embedded Modality Data module file for m∈ [symbol] ₊ dimensions of persistent homology (PH) producing a persistence diagram (PD) in the corresponding PH dimension and each of the PD(Hᵢ) modules, where 0≤i≤m, is then ingested into its corresponding Sub Diagram 1(PD(Hᵢ)) module, where 0≤i≤m and m is the prescribed number of dimensions of persistent homology, ingested into 9 topological metrics: 1) Persistent Entropy (PE), 2) Number of “Off Diagonal” Points (NoP), 3) the Bottleneck Distance Amplitude (Btl), 4) the q-Wasserstien Distance Amplitude (Wass), 5) The Persistence Landscape Amplitude (PL), 6) the Persistence Image Amplitude (PI), 7) the Betti Curve Amplitude (Bet), 8) the Persistence Silhouette Amplitude (Sil), and 9) the Persistence Heat Kernel (Heat) which produces a unique topological fingerprint for each ingested persistence diagram generated from the raw sensor modalities and storing as a 9 dimensional real valued vectors in the TDAML Feature Space data structure.

12. The method of claim 11 further comprising ingesting the TDAML Feature Space data structure into the Custom DL Model functional module as a feature space for training Deep Learning (DL) models and storing a trained TDAML DL model's data structure in the decision structure functional module.

13. The method of claim 12 wherein the DL model is a fully connected DNN with several hidden layers containing several thousand trainable parameters trained with a random train/test split (e.g., an 80/20, 70/30, etc. type train/test split) on supervised learning for binary/multi-classification of one or more mobile targets in a designated domain.
